(19) United States
(12) Patent Application Publication
(10) Pub. No.: US 2006/0113360 A1
(43) Pub. Date: Jun. 1, 2006

(54) Protective envelope with triangular bubble cushioning material

(75) Inventors: Chris C. Bartlett, Toronto (CA); Howard K. Cohen, Maple (CA)

Correspondence Address: BERESKIN AND PARR, 40 KING STREET WEST, BOX 401, TORONTO, ON, M5H 3Y2, CA

(73) Assignee: Cantar/Polyair Inc., Toronto (CA)

(21) Appl. No.: 10/999,968

(22) Filed: Dec. 1, 2004

(51) Int. Cl. B65D 27/00; B32B 3/26; B65D 81/02

(52) U.S. Cl. 229/68.1; 428/304.4; 206/523

(57) ABSTRACT

A cushioning envelope is provided. The envelope is constructed from a front panel and a rear panel connected to each other at a bottom edge and a pair of side edges. The front and rear panels have an outer layer and an inner cushioning layer. The inner cushioning layer is made from a cellular material, where cells have a triangular shape.

### FIELD OF THE INVENTION

The invention relates to protective envelopes, and in particular to protective envelopes with a generally triangular bubble cushioning material.

### BACKGROUND OF THE INVENTION

Protective envelopes are well known in the art. Typically, such envelopes have a paper outer layer and an inner cushioning layer formed from a sheet of plastic air cellular material. The cells of the cushioning layer have a hemispherical shape.

There is a need for a cushioning envelope which provides improved protection for delicate or fragile contents during transport.

### SUMMARY OF THE INVENTION

According to a first aspect of the present invention, an envelope is provided. The envelope comprises a front panel and a rear panel connected to each other at a bottom edge and a pair of side edges. The front and rear panels have an outer layer and an inner cushioning layer. The inner cushioning layer comprising a cellular material, where cells have a substantially triangular shape.

According to a second aspect of the present invention, a cushioning material is provided. The cushioning material comprises a sheet of cellular material with a plurality of cells having a substantially triangular shape. Preferably, each cell has an equilateral triangle shape, and the plurality of cells are arranged in groups of six cells, wherein each of the groups is positioned in a generally hexagonal configuration.

### BRIEF DESCRIPTION OF THE DRAWINGS

In the accompanying drawings:

FIG. 1 is a perspective view of a cushioning envelope according to a preferred embodiment of the present invention;

FIG. 2 is a cross-sectional view of the preferred embodiment;

FIG. 3 is a cross-sectional view of a portion of an envelope panel;

FIG. 4 is a plan view of a cushioning layer of the preferred embodiment, and

FIG. 5 is a plan view of an alternative embodiment of the cushioning envelope according to the present invention.

### DETAILED DESCRIPTION OF THE PREFERRED EMBODIMENTS

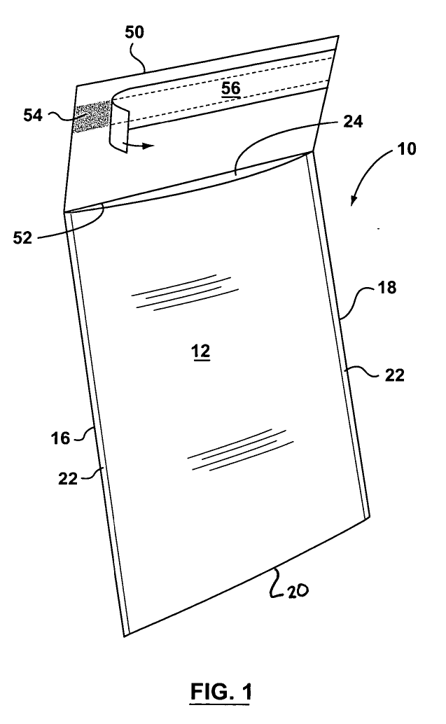

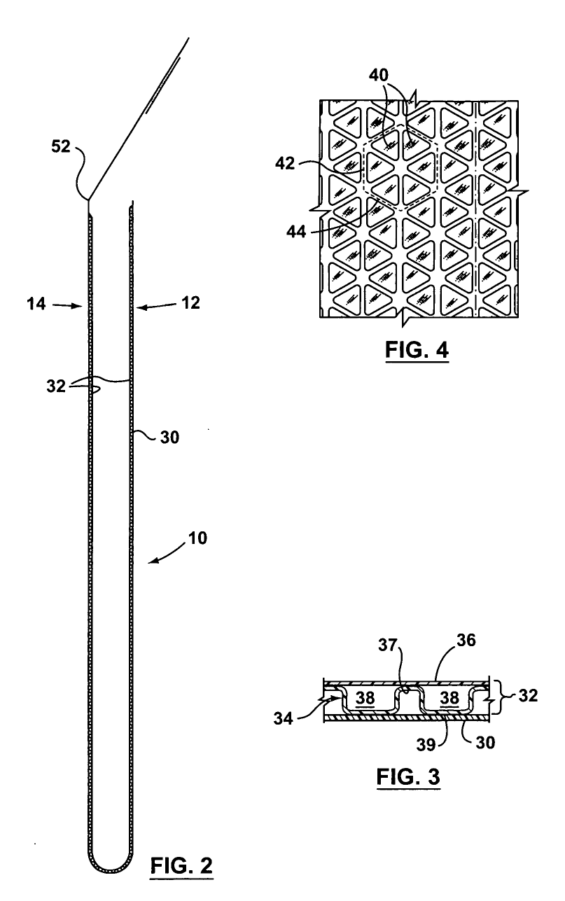

FIGS. 1 and 2 show an envelope 10 according to a preferred embodiment of the present invention. The envelope 10 includes a front panel 12 and a rear panel 14. The panels are joined at opposing side edges 16, 18 and at a bottom edge 20. Preferably, the front and rear panels 12, 14 are constructed from a single sheet of a multi-layer material (described in detail below), which is folded at bottom edge 20. The front and rear panels 12, 14 are bonded together at side edges 16, 18 by any suitable means, such as being heat sealed along heat seal strips 22. The front and rear panels 12, 14 define a storage space (not shown) between them which is accessed through an opening 24 in the top portion of the envelope 10.

Referring now to FIGS. 2 and 3, the multi-layer material (from which the front and rear panels 12, 14 are formed) includes an outer layer 30 and an inner cushioning layer 32. The outer layer 30 is preferably constructed from polyethylene, and may be corona treated if required for display of writing or illustrations (such as branding). More preferably, the outer layer is made from a composite material consisting of 1-15% high density polyethylene (HDPE), with the remainder consisting a combination of low density polyethylene (LDPE) and linear low density polyethylene (LLDPE).

Referring now to FIG. 3, the inner cushioning layer 32 is formed from an air-cellular material, which is itself formed from a first layer 34 and a second layer 36. The first layer 34 is a plastic film in which a plurality of spaced apart triangular-shaped cavities 38 are formed. The second layer 36 of plastic film is a substantially planar layer which is superimposed onto the first layer 34 and heat laminated onto land areas 37 of first layer 34 which surround the triangular cavities 38. First and second layers 34, 36 may be formed of any suitable thermoplastic film, such as low density polyethylene (including composites consisting of LDPE and LLDPE). Such films are well-known and commercially available.

The inner cushioning layer 32 is bonded to the outer layer 30 by heat laminating the distal portions 39 of the concave cavities 38 to the outer layer 30.

Referring now to FIGS. 3 and 4, the triangular cavities 38 of first layer 34 in combination with corresponding portions of second layer 36 define a plurality of cells 40 having a shape of a prism with opposing triangular faces defined by portions of first and second layers 34, 36. Preferably the triangular faces are in the shape of equilateral triangles. For convenience, the cells 40 will be referred hereinafter as “triangular cells” or “having a triangular shape”, and these terms shall refer to the prism shape described above.

Preferably, the triangular cells 40 are arranged in columns running generally parallel to the side edges 16, 18 of envelope 10. This configuration defines strips 42 of land areas running between adjacent columns of cells 40. In addition, each group six cells 40 (composed of two groups of three cells from adjacent columns) form a generally hexagonal configuration 44.

Referring again to FIGS. 1 and 2, a flap 50 is connected to a top edge 52 of rear panel 14. Preferably, the flap 40 is formed out of the same material as the outer layer 30 and is constructed integrally with the outer layer 30 of rear panel 14. Preferably, the top edge 52 is a fold to permit the flap 50 to open and close. The flap 50 includes an adhesive layer 54 coated on a portion thereof. The adhesive layer 54 may be composed of any suitable adhesive coating, or may be an additional layer of material covered with adhesive (such as two-sided tape). A keeper strip 56 is provided to cover the adhesive layer 54 prior to use.

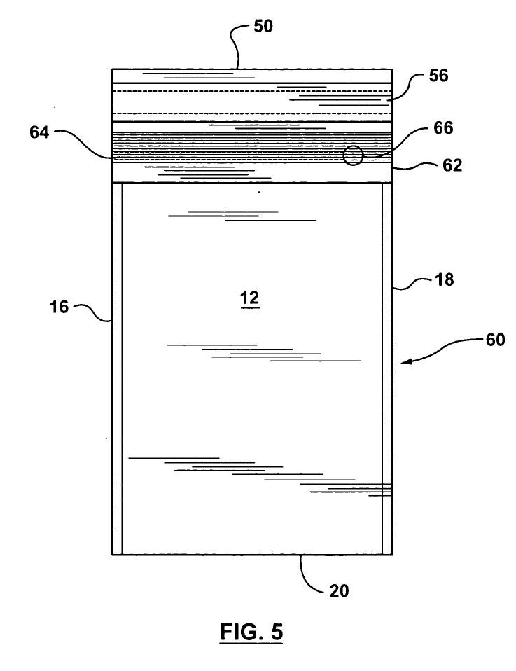

FIG. 5 shows an alternative embodiment of the protective envelope 60 according to the present invention. With the exception of certain features of the flap 50, the envelope 60 is identical to the envelope 10 of the preferred embodiment. Accordingly, like parts will be assigned like reference numbers and will not be further described.

Referring to FIG. 5, a strip of reinforcing tape 62 is provided on the inside of the flap 50. A perforated tear strip 64 is provided adjacent to the tape 62. A tab 66 is punched out of the end of the tear strip 64. The tear strip 64 is located between the top edge 52 and the keeper strip 56.

The tear strip facilitates opening of the sealed envelope 62 by the recipient. The recipient can grip the tab 66 to more easily pull on the tear strip 64. The tape 62 provides reinforcement so that the tear strip 62 will tear in a straight line along the edge of the tape 62.

The present invention provides several advantages over the prior art. The inventors have discovered that the triangular cells 40 of the cushioning layer 32 provide up to 53% more surface area of cushioning layer contact with a flat surface than traditional bubble cushioning material, thereby providing improved protection for envelope contents. In addition the linear strips 42 of land areas permit the envelope to fold more easily while providing cushioning for the envelope contents.

While the present invention as herein shown and described in detail is fully capable of attaining the above-described objects of the invention, it is to be understood that it is the presently preferred embodiment of the present invention and thus, is representative of the subject matter which is broadly contemplated by the present invention, that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” All structural and functional equivalents to the elements of the above-described preferred embodiment that are known or later come to be known to those of ordinary skill in the art are expressly incorporated herein by reference and are intended to be encompassed by the present claims. Moreover, it is not necessary for a device or method to address each and every problem sought to be solved by the present invention, for it is to be encompassed by the present claims.

1. An envelope comprising:
a) a front panel and a rear panel, at least one of the front and rear panels comprising an outer layer and an inner cushioning layer, the inner cushioning layer comprising a cellular material, the cellular material comprising a plurality of cells having a substantially triangular shape;
b) a bottom edge;
c) a pair of opposing side edges,
wherein the front panel is connected to the rear panel along the bottom edge and the side edges.

2. The envelope of claim 1, wherein the plurality of cells comprises a plurality of groups of six cells, wherein each of the groups is positioned in a generally hexagonal configuration.

3. The envelope of claim 2, wherein the substantially triangular shape comprises an equilateral triangle shape.

4. The envelope of claim 3, wherein each of the plurality of cells has a substantially identical shape.

5. The envelope of claim 4, wherein the cellular material is made from a plastic material and the plurality of cells are air-filled.

6. The envelope of claim 5, wherein the inner cushioning layer comprises:
a) a first layer of plastic film defining a plurality of spaced-apart triangular cavities and a plurality of land areas between the triangular cavities; and
b) a second layer of plastic film bonded to the first layer along the land areas;
wherein each cell is bounded by the cavity and a portion of the second layer covering the cavity;
wherein the first layer is bonded to the outer layer along a distal portion of the cavities.

7. The envelope of claim 6, wherein the plurality of cells are arranged in a plurality of columns running substantially parallel to the side edges, the plurality of columns defining a plurality of strips of the land areas therebetween.

8. The envelope of claim 7, wherein the front panel and the rear panel comprise the outer layer and the inner cushioning layer.

9. The envelope of claim 8, wherein the front and rear panels are integrally constructed and the bottom edge comprises a fold.

10. The envelope of claim 9, wherein each of the side edges comprises a heat seal strip.

11. The envelope of claim 6, wherein the first and second layer are formed from LDPE.

12. The envelope of claim 9, wherein the outer layer is corona treated.

13. The envelope of claim 9, wherein the outer layer has a composition of 1-15% HDPE.

14. The envelope of claim 6, wherein the rear panel comprises a flap connected to a top edge thereof.

15. The envelope of claim 14, further comprising an adhesive layer on a portion of the flap and a keeper strip removably covering the adhesive layer.

16. The envelope of claim 15, wherein the flap is integrally constructed with the outer layer of the rear panel, wherein the top edge comprises a fold.

17. The envelope of claim 17, wherein the flap comprises a tear strip located between the top edge of the rear panel and the adhesive layer.

18. The envelope of claim 17, further comprising reinforcing tape positioned proximate to the tear strip.

19. The envelope of claim 18, wherein the tear strip comprises a tab proximate to an end thereof.

20. A cushioning material comprising:
a sheet of cellular material, the sheet comprising a plurality of cells having a substantially triangular shape.

21. The cushioning material of claim 20, wherein the plurality of cells comprises a plurality of groups of six cells, wherein each of the groups is positioned in a generally hexagonal configuration.

22. The cushioning material of claim 21, wherein the substantially triangular shape comprises an equilateral triangle shape.

23. The cushioning material of claim 22, wherein each of the plurality of cells has an identical shape.

24. The cushioning material of claim 23, wherein the sheet is made from a plastic material and the plurality of cells are air-filled.

25. The cushioning material of claim 24, wherein the sheet comprises:
a) a first layer of plastic film defining a plurality of spaced-apart triangular cavities and a plurality of land areas between the triangular cavities; and
b) a second layer of plastic film bonded to the first layer along the land areas;
wherein each cell is bounded by the cavity and a portion of the second layer covering the cavity;
wherein the first layer is bonded to the outer layer along a distal portion of the cavities.

26. The cushioning material of claim 25, wherein the plurality of cells are arranged in a plurality of columns, the plurality of columns defining a plurality of substantially parallel strips of the land areas therebetween.
